(19) United States
(12) Patent Application Publication
(10) Pub. No.: US 2026/0177835 A1
(43) Pub. Date: Jun. 25, 2026

(54) UNIBODY CAMERA ANCHORING

(71) Applicant: Meta Platforms Technologies, LLC, Menlo Park, CA (US)

(72) Inventors: Zhilin Cong, San Francisco, CA (US); Lidu Huang, Danville, CA (US); Yizhi Xiong, Foster City, CA (US)

(21) Appl. No.: 19/418,769

(22) Filed: Dec. 12, 2025

Related U.S. Application Data
(60) Provisional application No. 63/736,495, filed on Dec. 19, 2024.

(51) Int. Cl. G02B 27/01; G02B 7/02; G03B 17/12; G03B 17/56; G03B 30/00

(52) U.S. Cl. CPC G02B 27/0176; G02B 7/026; G02B 27/0101; G02B 27/0149; G02B 27/0172; G03B 17/12; G03B 17/561; G03B 30/00; G02B 2027/0138; G02B 2027/0161

(57) ABSTRACT

A device includes a frame, a camera module including a lens barrel, and an integrated camera sheath and alignment collar (ICSAC) coupled with the frame. The ICSAC includes a camera sleeve region coupled around the lens barrel and a camera alignment collar region coupled around the lens barrel and configured to align the camera module with respect to the ICSAC and the frame. The ICSAC may be glued to the frame or molded into the frame. The camera alignment collar region may include a mechanical reference datum or self-locking spring features configured to mate to a lens barrel flange of the camera module.

### CROSS-REFERENCE TO RELATED APPLICATIONS

This application claims priority to U.S. provisional Application No. 63/736,495 filed Dec. 19, 2024, which is hereby incorporated by reference.

### TECHNICAL FIELD

This disclosure relates generally to optics, and in particular to cameras.

### BACKGROUND INFORMATION

Cameras are widely integrated into various electronic devices to capture images and video content for users. These devices include wearable electronics such as smart glasses and augmented reality headsets, portable electronics such as smartphones and tablets, and stationary electronics such as laptops and security cameras. The integration of cameras into these devices may utilize mounting systems that securely attach the camera modules to the device housing or frame. During the manufacturing process, camera modules may need to be aligned within their mounting systems to ensure optimal optical performance and image quality. The alignment and assembly of multiple separate components can introduce tolerance variations that may affect the final positioning and performance of the camera system within the device.

### SUMMARY

This summary is provided as a brief and simplified introduction to some of the concepts that are explained in greater detail in the Detailed Description that follows. It is not intended to identify key or essential features of the invention and it is not intended to be used to interpret or limit the scope of the claims.

According to an aspect of the present disclosure, a device is provided. The device may be a wearable. The device may be a head-mounted device. The head-mounted device includes a frame, a camera module including a lens barrel, and an integrated camera sheath and alignment collar (ICSAC) coupled with the frame. The ICSAC includes a camera sleeve region coupled around the lens barrel and a camera alignment collar region coupled around the lens barrel and configured to align the camera module with respect to the ICSAC and the frame. The camera sleeve region and the camera alignment collar region are formed of a contiguous material.

According to other aspects of the present disclosure, the head-mounted device may include one or more of the following features. The contiguous material may be metal. The ICSAC may be glued to the frame. The contiguous material may be plastic. The ICSAC may be molded into the frame and the frame may also be plastic. The camera alignment collar region may include a mechanical reference datum, and the camera module may include a mating surface fitted to align with the mechanical reference datum of the camera alignment collar region.

According to another aspect of the present disclosure, a device is provided. The device includes an exterior housing, a camera module including a lens barrel, and an integrated camera sheath and alignment collar (ICSAC) coupled with the exterior housing. The ICSAC includes a camera sleeve region coupled around the lens barrel and a camera alignment collar region coupled around the lens barrel and configured to align the camera module with respect to the ICSAC and the exterior housing. The camera sleeve region and the camera alignment collar region are formed of a contiguous material.

According to another aspect of the present disclosure, an integrated camera sheath and alignment collar (ICSAC) is provided. The ICSAC includes a camera sleeve region for surrounding a lens barrel of a camera module and a camera alignment collar region configured to align the camera module with respect to the ICSAC. The camera sleeve region and the camera alignment collar region are formed of a contiguous material.

According to another aspect of the present disclosure, a head-mounted device is provided. The head-mounted device includes a frame, a camera module including a lens barrel and a lens barrel flange, and an integrated camera sheath and alignment (ICSAC) coupled with the frame. The ICSAC includes a camera sleeve region coupled around the lens barrel and a camera alignment collar region including self-locking spring features configured to mate to the lens barrel flange of the camera module. The camera alignment collar region is configured to align the camera module with respect to the ICSAC and the frame, and the camera sleeve region and the camera alignment collar region are formed of a contiguous material.

According to other aspects of the present disclosure, the head-mounted device may include one or more of the following features. The contiguous material may be metal. The ICSAC may be glued to the frame. The contiguous material may be plastic. The ICSAC may be molded into the frame and the frame may also be plastic.

According to another aspect of the present disclosure, a device is provided. The device includes an exterior housing, a camera module including a lens barrel and a lens barrel flange, and an integrated camera sheath and alignment collar (ICSAC) coupled with the exterior housing. The ICSAC includes a camera sleeve region coupled around the lens barrel and a camera alignment collar region including self-locking spring features configured to mate to the lens barrel flange of the camera module. The camera alignment collar region is configured to align the camera module with respect to the ICSAC and the exterior housing, and the camera sleeve region and the camera alignment collar region are formed of a contiguous material.

According to another aspect of the present disclosure, an integrated camera sheath and alignment collar (ICSAC) is provided. The ICSAC includes a camera sleeve region coupled around a lens barrel of a camera module and a camera alignment collar region including self-locking spring features configured to mate to a lens barrel flange of the camera module. The camera alignment collar region is configured to align the camera module with respect to the ICSAC, and the camera sleeve region and the camera alignment collar region are formed of a contiguous material.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted display (HMD) that may include unibody camera anchoring, in accordance with aspects of the disclosure.

FIG. 2A illustrates a camera sleeve region for coupling around a lens barrel of a camera module, in accordance with aspects of the disclosure.

FIG. 2B illustrates a camera alignment collar region that may also be coupled around a lens barrel of a camera module, in accordance with aspects of the disclosure.

FIG. 2C illustrates an integrated camera sheath and alignment collar (ICSAC) that includes camera sleeve region and camera alignment collar region integrated together into a one-piece (unibody) component that is formed of a contiguous material (e.g., metal) in accordance with aspects of the disclosure.

FIG. 3A illustrates a temple area of a backside of frame of FIG. 1, in accordance with aspects of the disclosure.

FIG. 3B illustrates a cutaway view of an example camera module that includes an image sensor, a lens barrel flange, and lens barrel, in accordance with aspects of the disclosure.

FIG. 4A illustrates a camera sleeve region for coupling around a lens barrel of a camera module, in accordance with aspects of the disclosure.

FIG. 4B illustrates a collar region that may also be coupled around a lens barrel of a camera module, in accordance with aspects of the disclosure.

FIG. 4C illustrates a self-locking spring feature configured to mate to the lens barrel flange of the camera module, in accordance with aspects of the disclosure.

FIG. 5 illustrates integrated camera sheath and alignment (ICSAC) that includes camera sleeve region and camera alignment collar region integrated into a unibody piece formed of a contiguous material (e.g. metal or plastic), in accordance with aspects of the disclosure.

### DETAILED DESCRIPTION

Embodiments of unibody camera anchoring are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Camera modules in electronic devices traditionally employ a multi-component assembly approach for mounting and alignment within device housings. In conventional implementations, camera systems may utilize separate components including a bezel, a glass or sapphire window positioned in front of the camera, and a mounting alignment ring for camera attachment to the device frame. The bezel may provide structural support and aesthetic finishing around the camera opening, while the glass or sapphire window may serve as a protective barrier for the camera lens elements. The mounting alignment ring may facilitate proper positioning and securing of the camera module within the device housing.

The fabrication of these separate components may involve distinct manufacturing processes and materials. Each component may require individual machining, molding, or forming operations, followed by separate quality control and inspection procedures. The assembly process may involve sequential installation and alignment of each component, where the bezel, window, and mounting ring are positioned and secured in relation to one another and to the camera module.

This multi-component approach may increase the total number of manufacturing steps in the production process. Each additional component may contribute to extended assembly time, additional tooling requirements, and increased material handling operations. The separate fabrication and assembly processes may result in higher overall manufacturing costs due to the cumulative effect of multiple production stages and the associated labor and equipment utilization.

Tolerance variations may occur during the manufacturing and assembly of these separate components. Each component may have individual dimensional tolerances that can accumulate when the components are assembled together. Misalignment between the bezel, window, and mounting ring may affect the final positioning of the camera module within the device housing. Such tolerance stack-up may result in variations in the optical axis alignment of the camera system, potentially affecting image quality, focus accuracy, or field of view consistency across manufactured units.

The alignment process for multiple separate components may require precise positioning and securing mechanisms to maintain proper relationships between the components during and after assembly. Variations in component dimensions, surface finishes, or material properties may contribute to alignment challenges that can affect the overall performance and reliability of the camera mounting system.

To address the manufacturing and alignment challenges associated with multi-component camera mounting systems, a unibody design approach may be implemented. The unibody design may integrate a camera sleeve or sheath with an alignment collar into a single, contiguous component. This integrated approach may eliminate the need for separate bezel, window, and mounting ring components by combining their functions into a unified structure.

The unibody construction may be formed from contiguous metal or plastic material. When formed from metal, the unibody component may provide enhanced structural rigidity and durability for camera mounting applications. Metal construction may offer resistance to deformation under mechanical stress and may maintain dimensional stability across temperature variations. When formed from plastic material, the unibody component may provide weight reduction benefits and may enable integration with plastic device housings through molding processes.

A first design option may include a sleeve integrated with an alignment ring that incorporates a mechanical reference datum. The mechanical reference datum may provide a precise interface surface or feature that corresponds to a mating surface on the camera module. This mechanical interface may facilitate accurate positioning and alignment of the camera module relative to the device housing during assembly.

A second design option may include a sleeve integrated with an alignment ring that incorporates self-locking spring features. The self-locking spring features may provide shock absorption capabilities to protect the camera module from mechanical impacts or vibrations. The self-locking mechanism may enable snap-fit installation of the camera module, where the spring features engage with corresponding features on the camera module to provide both alignment and retention functions.

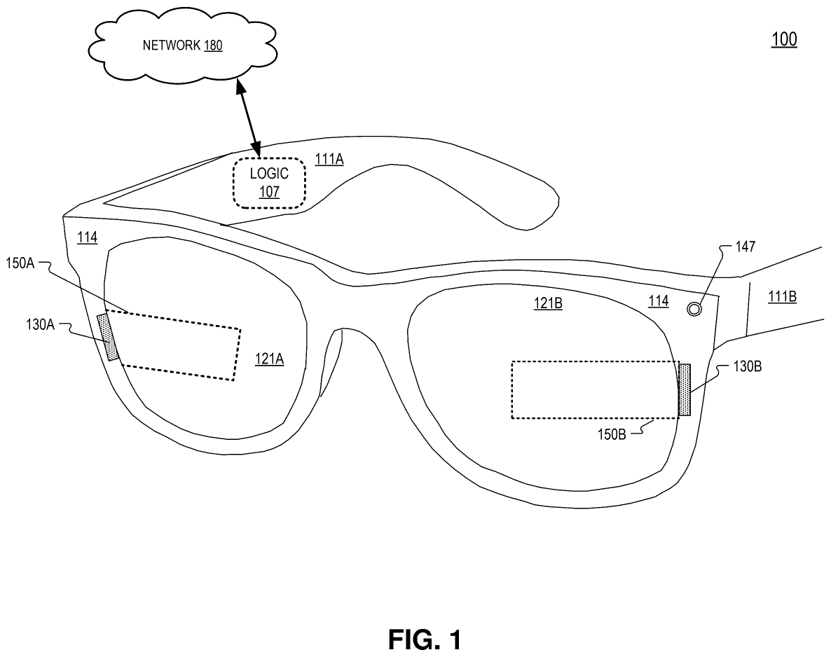

The unibody camera mounting approach may find application across multiple device categories with exposed camera architectures. In wearable devices, the integrated mounting system may be implemented in head-mounted displays, smart glasses, watches, and smart pins. The unibody design may provide space efficiency benefits in these constrained form factors while maintaining camera alignment accuracy. Implementations of the disclosure may be utilized in phones, tablets, laptops, home devices, security cameras, or otherwise. These and other embodiments are described in more detail in connections with FIGS. 1-5.

FIG. 1 illustrates a head-mounted display (HMD) 100 that may include unibody camera anchoring, in accordance with aspects of the present disclosure. HMD 100 may be configured to provide augmented reality or mixed reality functionality to a user. HMD 100 may include a frame 114 that serves as a primary structural component for supporting various optical and electronic elements. The frame 114 may be coupled to an arm 111A and an arm 111B that extend from opposite sides of the frame 114. The arms 111A and 111B may be configured to position and secure the head-mounted display 100 on or about a head of a wearer during use.

The frame 114 may support a lens assembly 121A and a lens assembly 121B that are positioned to align with the eyes of the wearer when the HMD 100 is worn. The lens assemblies 121A and 121B may include prescription lenses that are matched to a particular user of HMD 100. This customization capability may allow HMD 100 to accommodate users with different vision correction requirements while maintaining optical performance of the display system.

A display 130A and a display 130B may be integrated within HMD 100 to generate image light for presentation to the wearer. The displays 130A and 130B may include beam-scanning displays or liquid crystal on silicon (LCOS) displays for directing image light to the wearer. The display 130A may be associated with the lens assembly 121A, while the display 130B may be associated with the lens assembly 121B, enabling independent image presentation to each eye of the wearer.

As further shown in FIG. 1, a waveguide 150A and a waveguide 150B may be positioned within the respective lens assemblies to direct image light generated by the displays 130A and 130B to eyebox areas for viewing by the user. The waveguide 150A may receive image light from the display 130A and guide the light to the appropriate eyebox location, while the waveguide 150B may perform a similar function for image light from the display 130B. The waveguides 150A and 150B may enable the lens assemblies 121A and 121B to appear transparent to the user, facilitating augmented reality or mixed reality functionality by allowing the user to view scene light from the surrounding environment while simultaneously receiving image light from the displays.

The lens assemblies 121A and 121B may include two or more optical layers that provide different functionalities such as display, eye-tracking, and optical power correction. These multiple optical layers may be integrated within each lens assembly to combine various optical functions while maintaining the transparent appearance for augmented reality applications.

The frame 114 and the arms 111A and 111B may house supporting hardware components for HMD 100. Processing logic 107 may be integrated within the frame 114 or arms to execute operations for controlling HMD 100, including processing image data and managing display functions. The supporting hardware may also include wired and wireless data interfaces for sending and receiving data, graphic processors for image rendering and processing, and one or more memories for storing data and computer-executable instructions.

HMD 100 may be configured to receive power through wired or wireless power delivery systems. In some cases, HMD 100 may be powered by one or more batteries integrated within the frame 114 or arms 111A and 111B. HMD 100 may also be configured to receive data, including video data, via wired communication channels or wireless communication channels. The processing logic 107 may be communicatively coupled to external networks to provide data transmission and reception capabilities.

In the illustrated implementation of FIG. 1, HMD 100 includes a camera 147. Camera 147 may be directed to image an external environment of HMD 100. Camera 147 may include a lens assembly configured to focus image light to a complementary metal-oxide semiconductor (CMOS) image sensor, in some implementations. Camera 147 may be mounted on the frame 114 and be positioned on a front-facing camera. Camera 147 may utilize positioned using a unibody anchoring system, in accordance with aspects of the disclosure.

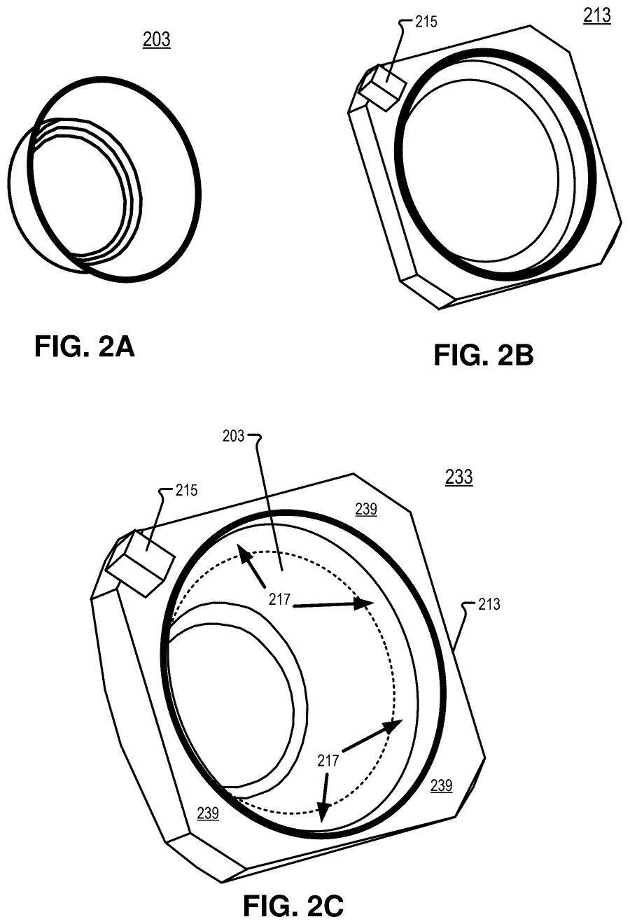

FIG. 2A illustrates a camera sleeve region 203 for coupling around a lens barrel of a camera module, in accordance with aspects of the disclosure. Camera sleeve region 203 may be configured for coupling around a lens barrel of a camera module. The camera sleeve region 203 may be formed as a cylindrical component with a hollow interior that may be dimensioned to receive and surround the lens barrel. In some cases, the camera sleeve region 203 may be formed from metal material, while the lens barrel that the camera sleeve region 203 surrounds may be formed from plastic material. This material combination may provide structural benefits where the metal camera sleeve region 203 may offer enhanced durability and dimensional stability, while the plastic lens barrel may provide weight reduction and cost advantages for the camera module construction.

FIG. 2B illustrates a camera alignment collar region 213 that may also be configured to couple around a lens barrel of a camera module, in accordance with aspects of the disclosure. The camera alignment collar region 213 may feature a chamfered rectangle outer profile that may provide structural interfaces for mounting and positioning within a device housing. The camera alignment collar region 213 may include a mechanical reference datum 215 that may assist in aligning a camera module during assembly operations. The mechanical reference datum 215 may be positioned to provide a precise interface surface or feature that may correspond to a mating surface on the camera module. In some cases, the camera module may include a mating surface that may be fitted to align with the mechanical reference datum 215 of the camera alignment collar region 213, facilitating accurate positioning and alignment of the camera module relative to the camera alignment collar region 213.

FIG. 2C illustrates an integrated camera sheath and alignment collar (ICSAC) 233 that may combine the camera sleeve region 203 and the camera alignment collar region 213 into a single unibody component, in accordance with aspects of the disclosure. The ICSAC 233 may be formed of a contiguous material, such as metal or plastic, that may eliminate the need for separate mounting and alignment components. The camera alignment collar region 213 may maintain the chamfered rectangle profile and may include a mechanical reference datum 235 that may provide alignment functionality. The camera sleeve region 203 may extend from the camera alignment collar region 213, forming a cylindrical portion that may be configured to surround a lens barrel of a camera module.

As further shown in FIG. 2C, a bottom surface 239 of the ICSAC 233 may be configured to couple to a lens barrel flange of a camera module. The bottom surface 239 may provide a mounting interface that may secure the camera module to the ICSAC 233 during assembly. The camera alignment collar region 213 may be configured to align the camera module with respect to the ICSAC 233 and a frame or exterior housing of a device. This alignment functionality may maintain proper positioning of the camera module within the device housing and may ensure consistent optical axis alignment.

In some cases, when the ICSAC 233 may be formed from metal material, the ICSAC 233 may be glued into a plastic frame of a wearable device. The adhesive bonding between the metal ICSAC 233 and the plastic frame may provide secure attachment while accommodating potential differences in thermal expansion between the materials. In other implementations, the ICSAC 233 may be formed from contiguous plastic material, which may enable integration with plastic device housings through molding processes or other plastic joining techniques.

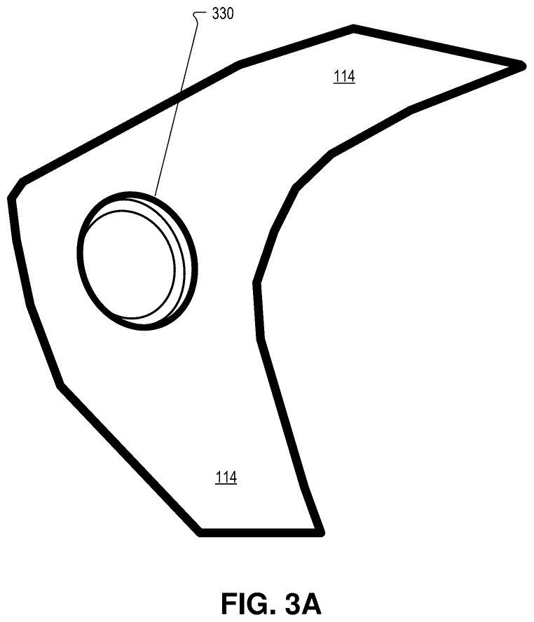

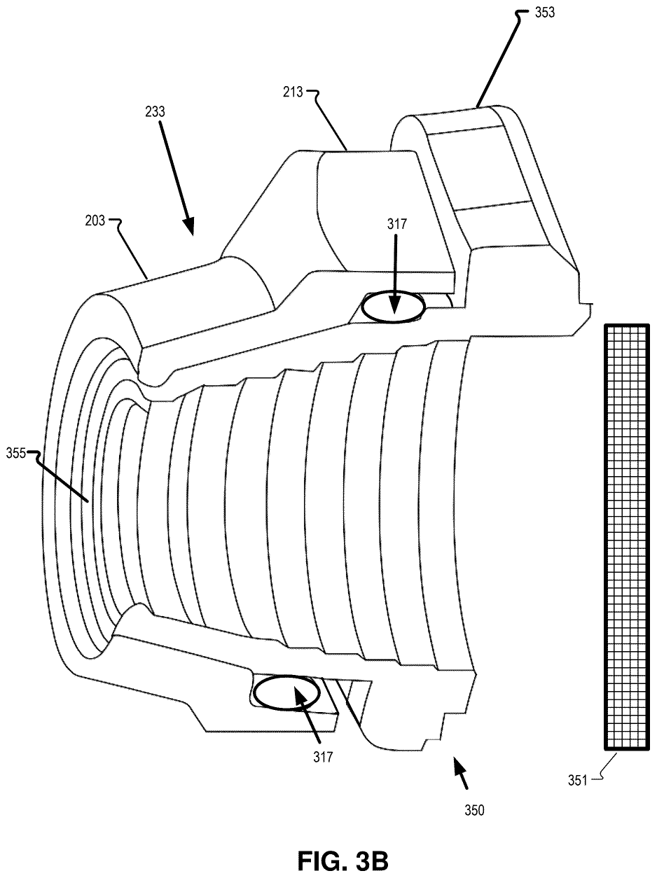

FIG. 3A shows a temple area of a backside of the frame 114 of FIG. 1, in accordance with aspects of the present disclosure. In some implementations, an integrated camera sheath and alignment collar (ICSAC) 330 may be molded into the frame 114 as a contiguous structure. ICSAC 330 may include the camera alignment collar region 213 that may be integrated within the frame structure during the molding process. When the ICSAC 330 is molded into frame 114, both the ICSAC 330 and the frame 114 may be formed from plastic material, enabling a unified construction that may eliminate the need for separate attachment mechanisms such as adhesives or mechanical fasteners.

ICSAC 330 may be configured to receive and align a camera module within the frame 114. The integration of the ICSAC 330 into the frame 114 may provide structural continuity between the camera mounting system and the device housing. This molded integration approach may maintain precise dimensional relationships between the camera mounting features and the frame 114, which may contribute to consistent camera positioning across manufactured units.

FIG. 3B illustrates a cutaway view of a camera module 350 that may be configured for integration with the ICSAC systems described herein. The camera module 350 may include an image sensor 351 that may be configured to convert incident image light into electrical signals for image capture and processing. The image sensor 351 may include complementary metal-oxide semiconductor (CMOS) technology or charge-coupled device (CCD) technology for light detection and signal conversion.

As further shown in FIG. 3B, the camera module 350 may include a lens barrel flange 353. The lens barrel flange 353 may extend radially outward from the camera module 350 and may include mounting features that correspond to alignment and retention features of the ICSAC systems.

The camera module 350 may also include a lens barrel 355 that may extend from the lens barrel flange 353. The lens barrel 355 may secure lens elements configured to focus image light to the image sensor 351. The lens elements within the lens barrel 355 may be arranged in an optical configuration that may provide focusing, magnification, and aberration correction functions for the camera system. The lens barrel 355 may be dimensioned to fit within the camera sleeve region of the ICSAC systems, where the camera sleeve region may surround and support the lens barrel 355 during operation.

The cutaway view reveals the internal arrangement of these components within the camera module 350, showing how the lens barrel 355 may be positioned relative to the lens barrel flange 353 and the image sensor 351. The cutaway view also shows that a gasket structure 317 may be disposed between camera alignment collar region 213 and lens barrel 355. Gasket structure 317 may be an O-ring, in some implementations. When lens barrel 335 is secured in ICSAC 233 during assembly, gasket structure 317 may assist in securing the camera module into ICSAC 233 in addition to providing environmental sealing to keep any external contaminants (e.g. moisture, dirt, sunscreen) from penetrating farther into the camera module 350. Gasket structure 317 may rest upon a mechanical sealant feature 217 illustrated in FIG. 2C of camera alignment collar region 213 in order to retain gasket structure 317.

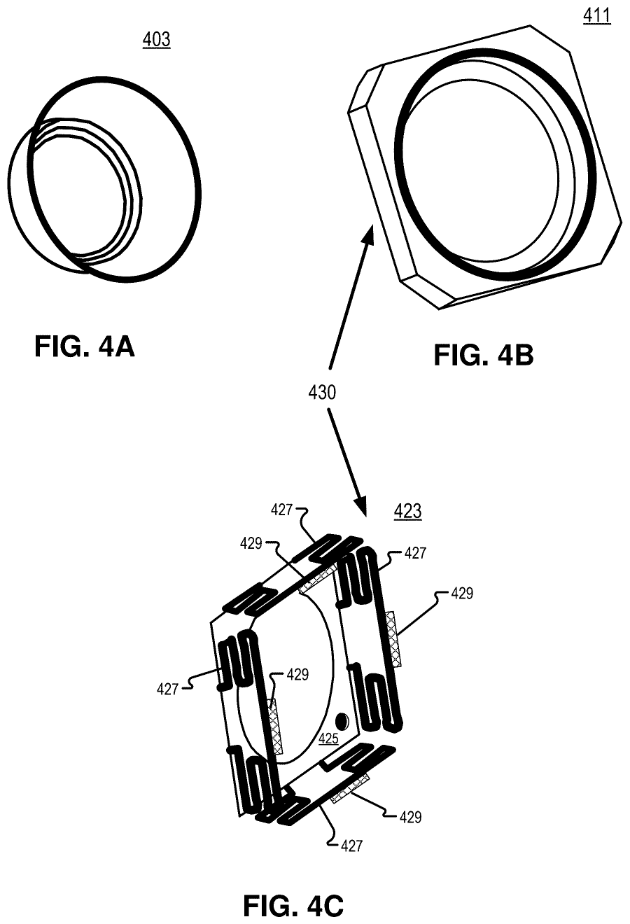

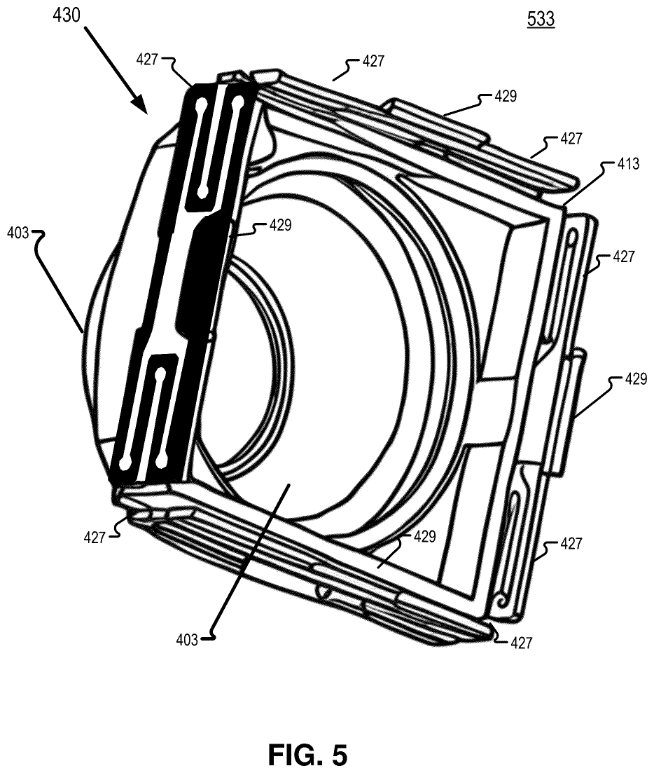

FIG. 4A illustrates a camera sleeve region 403 that may be configured for coupling around a lens barrel of a camera module, in accordance with aspects of the disclosure. The camera sleeve region 403 may be formed as a cylindrical component with a hollow interior that may be dimensioned to receive and surround the lens barrel during assembly and operation. In some cases, the camera sleeve region 403 may be formed from metal material, while the lens barrel that the camera sleeve region 403 surrounds may be formed from plastic material.

FIG. 4B illustrates a collar region 411 that may also be configured to couple around a lens barrel of a camera module, in accordance with aspects of the disclosure. The collar region 411 may feature a chamfered rectangle outer profile that may provide structural interfaces for mounting and positioning within a device housing or frame. The collar region 411 may include a central circular opening that may be configured to accommodate the lens barrel and provide alignment functionality for camera module positioning. The chamfered rectangle of the collar region 411 may facilitate secure mounting and may prevent rotation of the camera module during assembly or operation.

FIG. 4C illustrates a self-locking spring feature 423 that may be configured to mate to the lens barrel flange of a camera module, in accordance with aspects of the disclosure. The self-locking spring feature 423 may be combined with the collar region 411 to form a camera alignment collar region 430 that may provide both alignment and retention functions for camera module mounting. The self-locking spring feature 423 may enable snap-fit installation of the camera module, where spring elements engage with corresponding features on the camera module to provide secure attachment.

The self-locking spring feature 423 may include multiple springs 427 that may be distributed around the perimeter of the camera alignment collar region 430. The springs 427 may allow for flexibility under mechanical load while maintaining secure retention of the camera module within the mounting system. The springs 427 may also provide shock absorption capabilities that may protect the camera module from mechanical impacts or vibrations that may occur during device operation or handling.

The self-locking spring feature 423 may also include multiple locking mechanisms 429 that may be configured to engage with corresponding features on the lens barrel flange of the camera module. The locking mechanisms 429 may be positioned to snap onto the lens barrel flange during assembly, providing both alignment and retention functions. In some cases, the lens barrel flange of the camera module may include notches that the locking mechanisms 429 may snap into to align the camera module with respect to the camera alignment collar region 430. This notched engagement may ensure proper rotational and axial positioning of the camera module during assembly.

The locking mechanisms 429 may be shaped like extruded triangles that may provide engagement surfaces for interfacing with the lens barrel flange features. The triangular shape of the locking mechanisms 429 may facilitate insertion of the camera module during assembly while providing secure retention once the locking mechanisms 429 engage with the corresponding notches or features on the lens barrel flange.

In the illustrated implementation, four springs 427 and four locking mechanisms 429 may be distributed around the camera alignment collar region 430 to provide balanced support and retention for the camera module. The distribution of multiple springs 427 and locking mechanisms 429 may ensure uniform loading and may prevent tilting or misalignment of the camera module during installation or operation. In some implementations, the camera alignment collar region 430 may include only two springs 427 and two locking mechanisms 429, which may provide adequate retention and alignment functionality while reducing manufacturing complexity.

FIG. 5 illustrates an integrated camera sheath and alignment collar (ICSAC) 533 that may combine the camera sleeve region 403 and the camera alignment collar region 430 into a unibody component formed of a contiguous material. The camera sleeve region 403 may form a cylindrical structure that may be configured to couple around a lens barrel of a camera module, while the camera alignment collar region 430 may extend outward from the camera sleeve region 403 and may include the self-locking spring features configured to mate with the lens barrel flange of the camera module. Since locking mechanisms 429 may facilitate alignment and retention to the lens barrel flange of a camera module, the mechanical reference datum 215 of FIG. 2B may not be necessary.

The camera alignment collar region 430 may incorporate the multiple springs 427 and locking mechanisms 429 that may be distributed around the perimeter of the structure. The springs 427 may provide flexibility and shock absorption capabilities, while the locking mechanisms 429 may be configured to snap onto and secure the lens barrel flange of the camera module. The locking mechanisms 429 may extend from the springs 427 and may be positioned to engage with corresponding notches or features on the camera module for alignment and retention functions.

The term “processing logic” (e.g. processing logic 107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head-mounted device comprising:
a frame;
a camera module including a lens barrel; and
an integrated camera sheath and alignment collar (ICSAC) coupled with the frame, the ICSAC including:
a camera sleeve region coupled around the lens barrel; and
a camera alignment collar region coupled around the lens barrel and configured to align the camera module with respect to the ICSAC and the frame, wherein the camera sleeve region and the camera alignment collar region are formed of a contiguous material.

2. The head-mounted device of claim 1, wherein the contiguous material is metal.

3. The head-mounted device of claim 2, wherein the ICSAC is glued to the frame.

4. The head-mounted device of claim 1, wherein the contiguous material is plastic.

5. The head-mounted device of claim 4, wherein the ICSAC is molded into the frame and the frame is also plastic.

6. The head-mounted device of claim 1, wherein the camera alignment collar region includes a mechanical reference datum.

7. The head-mounted device of claim 6, wherein the camera module includes a mating surface fitted to align with the mechanical reference datum of the camera alignment collar region.

8. The head-mounted device of claim 1, wherein the camera module further includes a lens barrel flange.

9. The head-mounted device of claim 8, wherein the camera alignment collar region includes self-locking spring features configured to mate to the lens barrel flange of the camera module.

10. The head-mounted device of claim 9, wherein the self-locking spring features include springs and locking mechanisms.

11. The head-mounted device of claim 10, wherein the locking mechanisms are shaped as extruded triangular projections.

12. An integrated camera sheath and alignment collar (ICSAC) comprising:
a camera sleeve region for surrounding a lens barrel of a camera module; and
a camera alignment collar region configured to align the camera module with respect to the ICSAC, wherein the camera sleeve region and the camera alignment collar region are formed of a contiguous material.

13. The ICSAC of claim 12, wherein the contiguous material is metal.

14. The ICSAC of claim 12, wherein the contiguous material is plastic.

15. The ICSAC of claim 12, wherein the camera alignment collar region includes a mechanical reference datum configured to align with a mating surface of the camera module.

16. A device comprising:
a frame;
a camera module including a lens barrel and a lens barrel flange; and
an integrated camera sheath and alignment collar (ICSAC) coupled with the frame, the ICSAC including:
a camera sleeve region coupled around the lens barrel; and
a camera alignment collar region including self-locking spring features configured to mate to the lens barrel flange of the camera module, wherein the camera alignment collar region is configured to align the camera module with respect to the ICSAC and the frame, and wherein the camera sleeve region and the camera alignment collar region are formed of a contiguous material.

17. The device of claim 16, wherein the contiguous material is metal.

18. The device of claim 17, wherein the ICSAC is glued to the frame.

19. The device of claim 16, wherein the contiguous material is plastic.

20. The device of claim 16, wherein the self-locking spring features include springs and locking mechanisms that snap onto the lens barrel flange.
